(19) United States
(12) Patent Application Publication
(10) Pub. No.: US 2005/0285012 A1
(43) Pub. Date: Dec. 29, 2005

(54) Security support assembly

(76) Inventor: Toby E. Walton, Washington, MA (US)

Correspondence Address: MCCORMICK, PAULDING & HUBER LLP, CITY PLACE II, 185 ASYLUM STREET, HARTFORD, CT, 06103, US

(21) Appl. No.: 11/121,424

(22) Filed: May 4, 2005

Related U.S. Application Data
(60) Provisional application No. 60/567,572, filed on May 4, 2004.

(51) Int. Cl. A47G 23/02; F16M 13/00

(52) U.S. Cl. 248/551

(57) ABSTRACT

A security support assembly includes a base having a top, a bottom and sides that together define an interior chamber of the base. The base is designed such that the interior chamber is filled with a resilient material to absorb ballistic projectiles or concussive force.

### CROSS REFERENCE TO RELATED APPLICATIONS

This application claims the benefit of U.S. Provisional Application Ser. No. 60/567,572, filed on May 4, 2004, herein incorporated by reference in its entirety.

### FIELD OF THE INVENTION

This invention relates in general to a security support assembly, and deals more particularly with a security support assembly that includes an improved base for accommodating materials useful in deflecting or protecting against blast and ballistic projectiles, as well as concussive force.

### BACKGROUND OF THE INVENTION

Chairs, benches and the like have evolved over the years to accommodate not only changes in style, but changes in technology as well. That is, the particular design of support apparatuses has always been driven by a combination of aesthetics and material considerations. What has not changed over the years, however, is the desire to produce high quality support apparatuses, which meet the functional or aesthetic requirements of their owners.

One challenge facing producers of support apparatuses is to design a bench that meets certain criteria, including having a simple, attractive design which is capable of being employed in commercial, residential and public areas. The capability of appearance modification and the ability to be mass produced using a number of materials with differing dimensions has also been problematic, as well as shipping components which facilitate ease of construction at a given destination.

In addition, the manner in which the constituent elements of any support apparatus are held together has a great bearing on the longevity of the support apparatus, as well as bearing on the ability of the support apparatus to withstand environmental and criminal insults.

With the forgoing problems and concerns in mind, the present invention therefore seeks to provide a security support assembly which not only may be easily altered to meet many of the design needs of the varying requirements of architects, designers and city planners, but also provides an improved base for accommodating materials useful in deflecting or protecting against blast and ballistic projectiles.

### SUMMARY OF THE INVENTION

The recessed support and bracket may be used in conjunction to support, fasten, and hold rigid the pieces or surfaces supported. The support configuration can also be utilized to support a multitude of requirements including, but not limited to, benches, beds, stackable bookcases, tables and bridge abutments, while utilizing various natural and man made materials. The configuration dimensions may be altered to accept the supported material while maintaining the original concept and utilizing a variety of fastening methods.

Problems of design requirements while keeping structural integrity have been addressed by the present invention. The design may therefore be altered to identify with local architecture and/or enhance a particular setting while keeping the integral structure of the piece intact.

Shipping problems have been addressed by allowing the completed bench to be shipped as separate pieces with completed assembly of the horizontal surface to be supported with minimal effort, time, experience or expense.

Theft is curtailed by the weight and integrity of construction. While some fasteners are apparent to those looking for them, others may be hidden and impossible to remove without taking the side rails off first, which are themselves integrally attached to the top surface. Further security may be accomplished by various methods of affixing the supports themselves to the ground or pavement.

The “wracking” of the completed piece is prohibited as the supported surface is integrally attached to the side pieces, ergo, secured on two adjacent planes, which may be at approximately 90 degrees from each other.

Further, a back may be added at the time of assembly, or later, utilizing a number of different design or fastening methods.

For less expensive or less demanding requirements of stability and integrity, a simple metal, wooden or man made material brace may be utilized in lieu of or in addition to the deigned metal bracket.

It is another object of the present invention to provide a security support assembly that includes a multi-positional base structure which may be filled with anti-ballistic or blast materials.

According to one embodiment of the present invention, a security support assembly includes a base having a top, a bottom and sides that together define an interior chamber of the base. The base is designed such that the interior chamber is filled with a resilient material to absorb ballistic projectiles or concussive force.

These and other objectives of the present invention, and their preferred embodiments, shall become clear by consideration of the specification, claims and drawings taken as a whole.

### BRIEF DESCRIPTION OF THE DRAWINGS

FIG. 1 is a top plan of the recessed support according to one embodiment of the present invention.

FIG. 2 is a front elevational view of the recessed support illustrated in FIG. 1.

FIG. 3 is a side elevation view of the recessed support illustrated in FIG. 1.

FIG. 4 is a partial cross-sectional perspective view of the recessed support assembly according to one embodiment of the present invention.

FIG. 5 is a perspective view of the recessed support illustrated in FIGS. 1-3.

FIG. 6 is a front elevational view of the recessed support in a design-modified form, according to another embodiment of the present invention.

FIG. 7 is a front elevational view of the recessed support in a design-modified form, according to another embodiment of the present invention.

FIG. 8 is a front elevational view of the recessed support in a design-modified form, according to another embodiment of the present invention.

FIG. 9 is a front elevational view of the recessed support in a design-modified form, according to another embodiment of the present invention.

FIG. 10 is a front elevational view of the recessed support in a design-modified form, according to another embodiment of the present invention.

FIG. 11 is the recessed support in a design-modified form, according to another embodiment of the present invention.

FIG. 12 is a front elevational view of the recessed support in a design-modified form, according to another embodiment of the present invention.

FIG. 13 is a perspective view of a cooperating bracket with ends, according to one embodiment of the present invention.

FIG. 14 illustrates the use of the bracket illustrated in FIG. 13.

FIG. 15 is a perspective view of a cooperating bracket without ends, according to another embodiment of the present invention.

FIG. 16 illustrates the use of the bracket illustrated in FIG. 15.

FIG. 17 illustrates the use of a cooperating bracket according to another embodiment of the present invention.

FIG. 18 illustrates the use of a cooperating bracket according to another embodiment of the present invention.

FIG. 19 illustrates the use of a cooperating bracket according to another embodiment of the present invention.

FIG. 20 illustrates the use of the bracket illustrated in FIG. 19.

FIG. 21 is a front elevational view of the recessed support in a design-modified form, according to another embodiment of the present invention.

FIG. 22 is a front elevational view of the recessed support in a design-modified form, according to another embodiment of the present invention.

FIG. 23 is a front elevational view of the recessed support in a design-modified form, according to another embodiment of the present invention.

FIG. 24 is a front elevational view of the recessed support in a design-modified form, according to another embodiment of the present invention.

FIG. 25 is a front elevational view of the recessed support in a design-modified form, according to another embodiment of the present invention.

FIG. 26 is side view of a security support assembly according to another embodiment of the present invention.

FIG. 27 is an isometric view of a security support assembly according to another embodiment of the present invention.

FIG. 28 is side view of a security support assembly according to another embodiment of the present invention.

FIG. 29 is side view of a security support assembly according to another embodiment of the present invention.

FIG. 30 illustrates bench seating components, in accordance with another embodiment of the present invention.

### DETAILED DESCRIPTION OF THE INVENTION

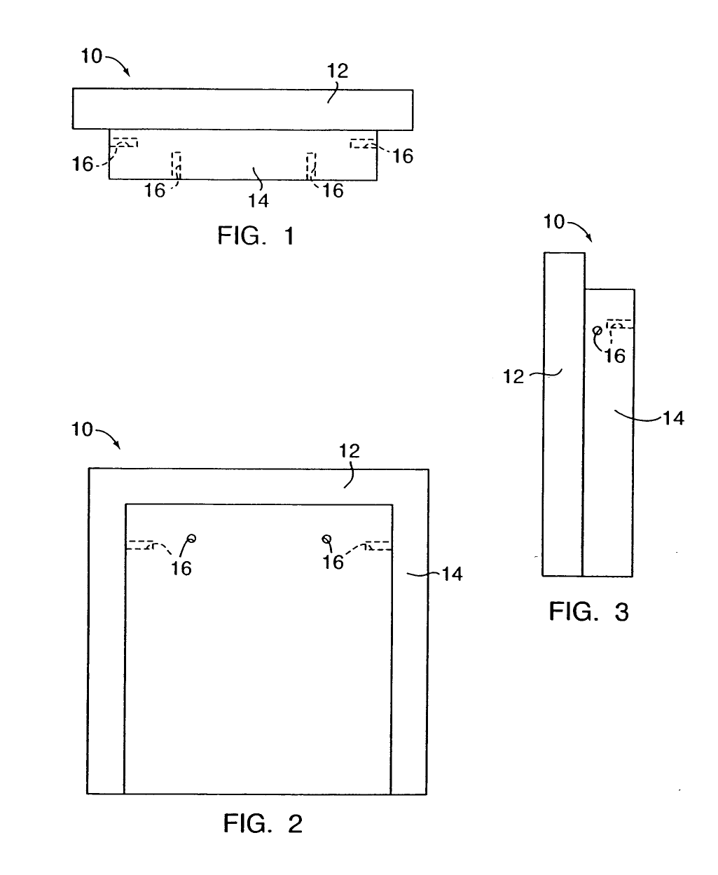

FIG. 1 illustrates a top view of a recessed support 10, according to one embodiment of the present invention. As shown in FIG. 1, the recessed support 10 includes an upright member 12 and a ledge member 14. Although shown as two distinct pieces in FIG. 1, the upright member 12 and the ledge member 14 may alternatively be formed integral with one another without departing from the broader aspects of the present invention.

As also shown in FIG. 1, the ledge member 14 includes a plurality of attachment bores 16 formed therein. The attachment bores 16 are themselves utilized to anchor a non-illustrated support bracket, which will be described in more detail later. The bores 16 may be integrally formed with the ledge member 14 or, in the preferred method, drilled in the ledge member 14 after formation of the ledge member 14. It will be readily appreciated that the recessed support 10 is used in pairs as matching ends for supporting an elevated bridging element, or elements, as will also be described in more detail later.

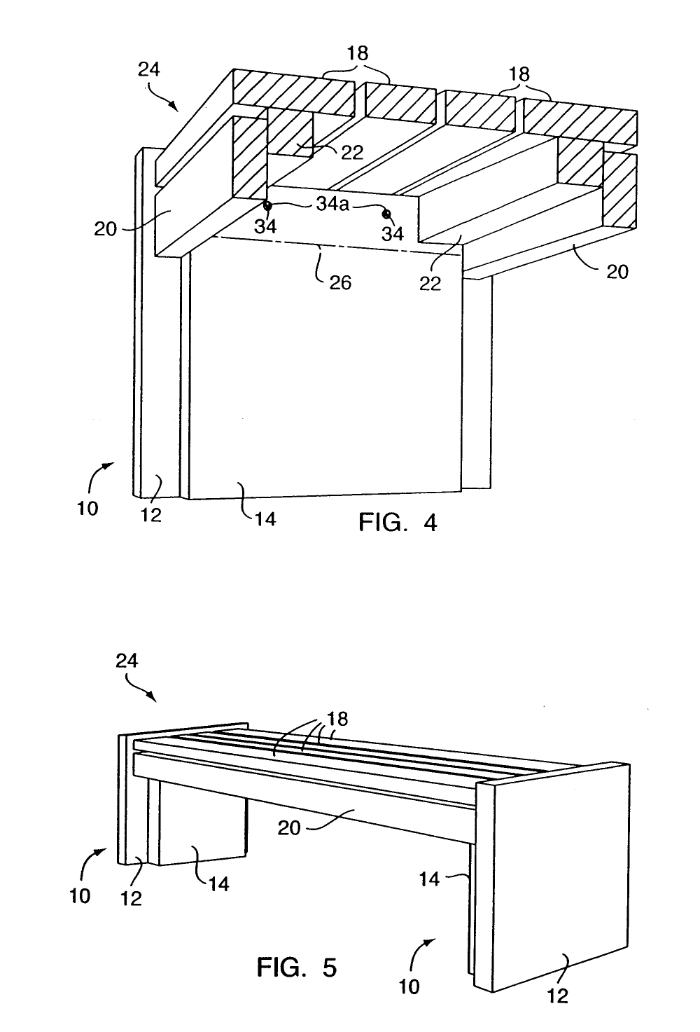

FIG. 2 illustrates a front elevational view of the recessed support 10, while FIG. 3 illustrates a side view of the recessed support 10. FIG. 4 depicts the recessed support 10 as it is utilized to support a plurality of horizontally oriented bridging elements 18. Moreover, as shown in FIG. 4, a pair of vertically oriented side elements 20 are affixed to a matching pair of inner, longitudinal brace elements 22 which are themselves fixedly connected to the bridging elements 18. The brace elements 22 serve to not only provide a surface upon which to hang the side elements 20, but also act with the side elements 20 to prevent racking or twisting of a recessed support assembly 24, as shown in FIG. 4. FIG. 5 illustrates one proposed embodiment of the recessed support assembly 24 wherein a pair of the recessed supports 10 are utilized to form opposing ends of an integrated bench.

It will be readily appreciated that the recessed support 10 of the present invention may be fabricated from stone, metal, wood, composite, plastics, concrete or other aggregates, natural or man made materials or other non-descript materials. In a similar vein, the bridging elements 18, as well as the side elements 20 and the brace elements 22, may also be constructed from any known material without departing from the broader aspects of the present invention.

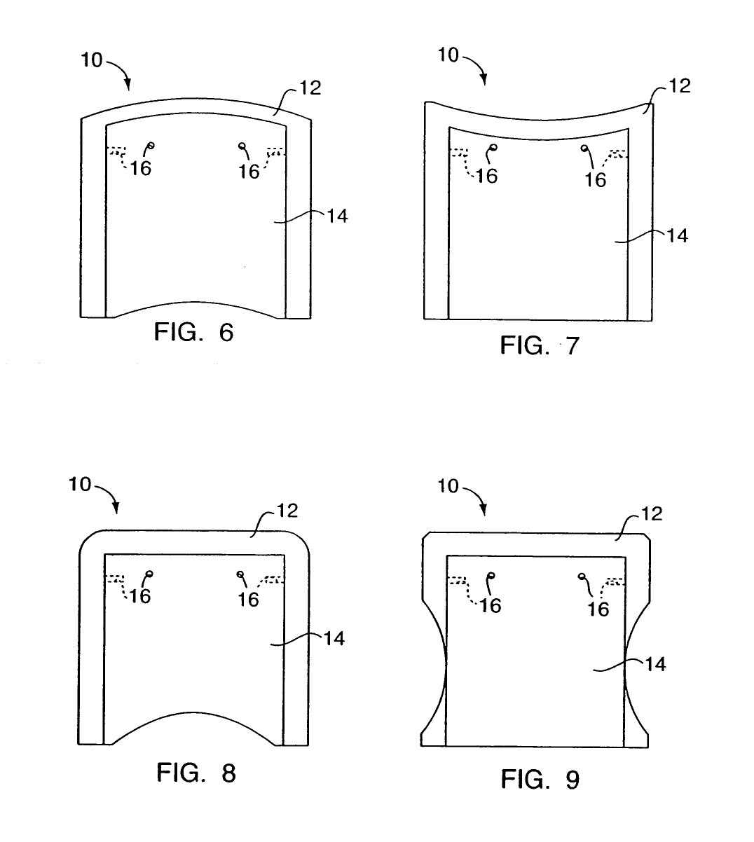

The upright member 12 may be horizontal, convex, concave or comprise a wave configuration, allowing for various seating or supporting designs, as is shown in the alternative embodiments depicted in FIGS. 6-9. As specifically shown in FIGS. 6-8, the ledge member 14 may also include convex, concave or other wave profiles which can be combined with similarly curved profiles of the upright member 12 to produce a large number of possible shape permutations for the recessed support assembly 24. Common to each of these configurations is that the distal ends of the bridging elements 18 are supported upon the ledge member 14 and affixed thereto. In this regard, the bridging elements 18 may be affixed to the ledge member 14 by a multitude of fastening methods including, but not limited to, screws, bolts, complimentary fixtures, pegs, nails, adhesives, cohesive forces, brackets or other methods or braces, as will be described in more detail later.

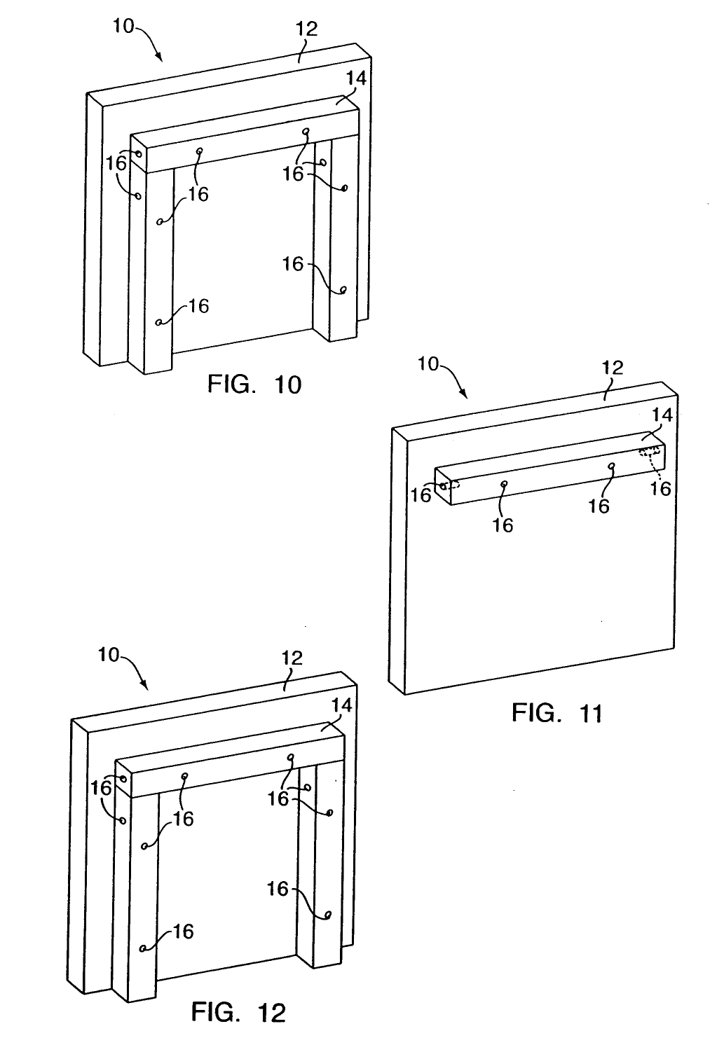

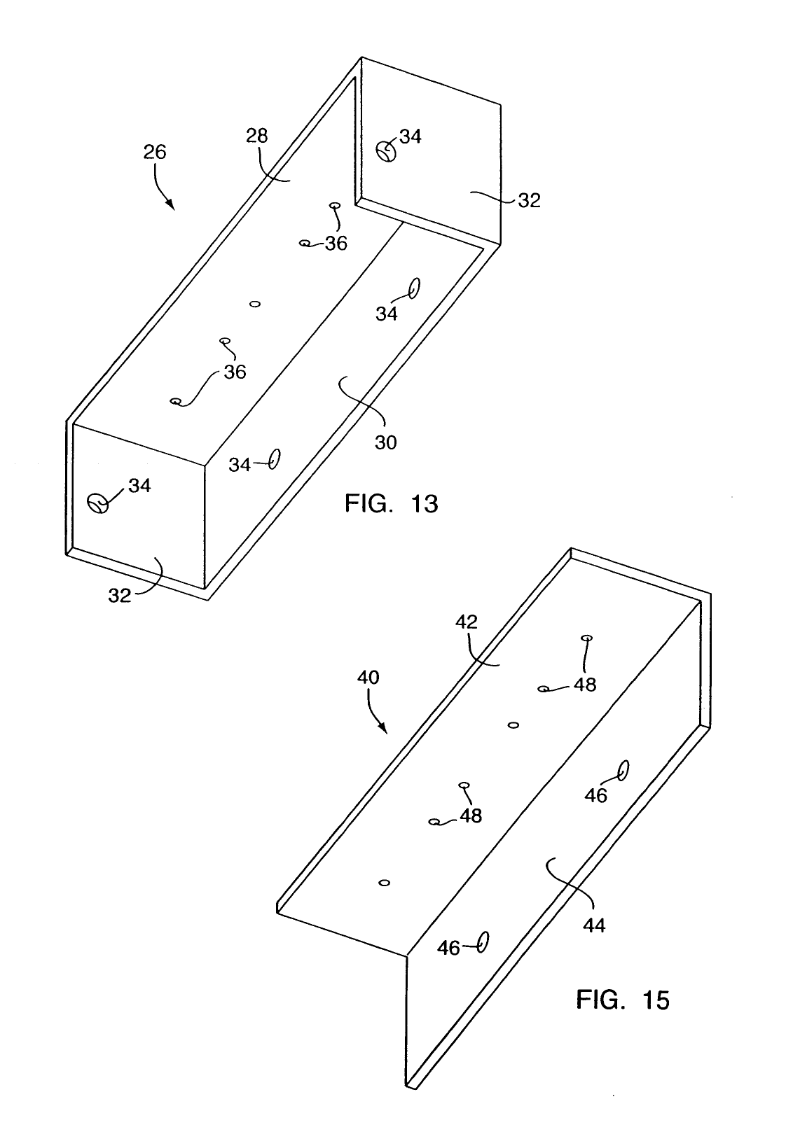

Although the ledge member 14 has been shown as being substantially coextensive with the planar surface of the upright members 10, the present invention is not limited in this regard. As shown in FIG. 10, the ledge member 14 may instead be formed from three rectangular support members with associated bores 16 formed therein. FIGS. 11 and 12 show even more alternative embodiments of the recessed support 14.

As discussed previously, one preferred method of attaching the bridging elements 18 to the recessed support 10 is the use of a preformed bracket 26, which may be affixed to the ledge member 14 as well as to the bridging element(s) 18. FIG. 13 illustrates a preferred embodiment of the preformed bracket 26 which includes a horizontal segment 28 and a vertical segment 30 disposed approximately 90° from one another. As also shown in FIG. 13, the bracket 26 further includes a pair of bracket end caps 32 arranged on either distal end of the bracket 26.

The bracket 26 is preferably formed from a thick gauge metal and includes a plurality of securement apertures 34 which are spaced so as to conform to the plurality of bores 16 formed in the ledge member 14, shown in FIGS. 1-3. A plurality of attachment apertures 36 are also formed through the horizontal segment 28 and are themselves utilized to fixedly hold the bridging elements 18 in place.

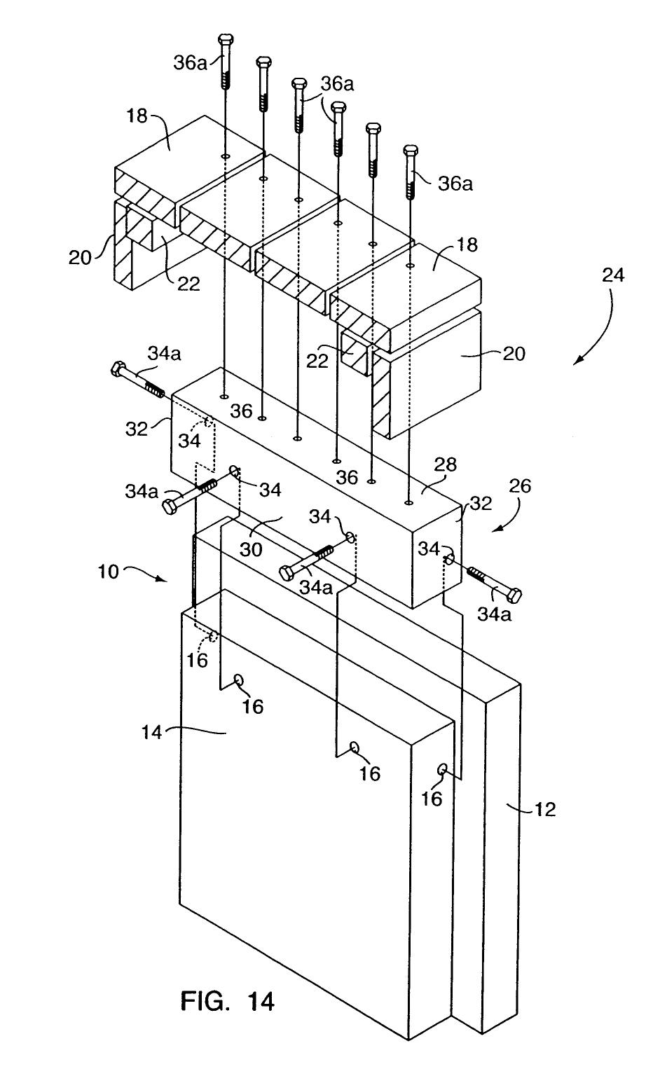

FIG. 14 illustrates the method of attaching the bracket 26 to the recessed support 10. As shown in FIG. 14, the bracket 26 is placed over the upper surface of the ledge member 14, thereby aligning the bores 16 with the securement apertures 34. A plurality of first fastening devices 34a, i.e. expansion bolts, or the like, are then utilized to secure the bracket 26 to the ledge member 14 leaving the attachment apertures 36 free to fix the bridging elements 18 thereto. A plurality of second fastening devices 36a, i.e. expansion bolts, or the like, are then utilized to secure the bracket 26 to the bridging elements 18. It should be noted that the preferred method of assembly includes securing the bracket 26 to the bridging elements 18 prior to fixing the bracket 26 to the ledge member 14, however combining the elements of the present invention in a differing sequence is also contemplated by the present invention. Moreover, it will be readily appreciated that the bracket 26 is sized and shaped to accommodate the profile of any particular ledge member 14, including those having curved or wave-form profiles as depicted in FIGS. 6-8.

Construction of the recessed support assembly 24 will now be described in conjunction with FIGS. 4, 5 and 14. As previously discussed, the recessed support 14 and the bracket 26 are first formed having a matching, and aligned, plurality of bores 16 and securement apertures 34. Prior to securing the bracket 26 to the ledge member 14, the bridging elements 18 are affixed to the bracket 26 by screwing up through the attachment apertures 36 and into the horizontal bridging elements 18. While a screwing operation has been described, the present invention is not limited in this regard as alternative methods and similar devices may be utilized without departing from the broader aspects of the present invention, provided that they extend up through the attachment apertures 36 and into the horizontal bridging elements 18.

It is therefore an important aspect of the present invention that the underside of the bridging elements 18 are secured to the bracket 26 so as not to mar the surface of the bridging elements 18 once the recessed support assembly 24 is fully assembled. Moreover, by attaching the bridging elements 18 in such a manner, the present invention effectively hides the screws, or the like, which are utilized to fixedly attach the bridging elements 18 to the bracket 26 and thereby effectively ensures that the ledge member 14 and the bridging elements 18 may not be disengaged from one another, as will be discussed in more detail later.

Returning to FIGS. 4, 5 and 14, after the bridging elements 18 have been affixed to the bracket 26, the bracket 18 is then arranged over the upper surface 38 of the ledge member 14. Once so positioned, a plurality of expansion bolts, or the like, are then used to fixed mate the securement apertures 34 of the bracket 18 to the bores 16 of the ledge member 14, thus firmly seating the bracket 26 to the ledge member 14. As mentioned above, once the bracket 26 is firmly seated upon the ledge member 14, the operative end of the screws utilized to affix the bridging elements 18 to the bracket 26 are effectively hidden and captured between the bracket 26 and the ledge member 14.

In order to prevent racking of the recessed support assembly 24 as a whole, a pair of the brace elements 22 may be position underneath the bridging elements 18, along the longitudinal sides of the recessed support assembly 24. The brace elements 22 may then be attached to the bridging elements 18 by screwing, or otherwise fastening, up through the brace elements 22 and into the bridging elements 18. Thus, the exterior surface of the bridging elements 18 are maintained free from any observable fastening mechanism and are therefore more aesthetically appealing.

A pair of the side elements 24 may also be attached to the brace elements 22 and also help protect the recessed support assembly 24 from warping or racking over time. The side elements 20 also add to the aesthetic nature of the recessed support assembly 24 while hiding the expansion bolts positioned through each of the securement apertures 34 formed in the bracket end caps 32.

It is therefore another important aspect of the present invention that, once attached to the brace elements 22 via screws or the like, the side elements 20 hide the expansion bolts positioned through each of the securement apertures 34 formed in the bracket end caps 32, thereby effectively frustrating any attempt by thieves, vandals or the like from having access to the fasteners of the recessed support assembly 24. Moreover, the end caps 32 of the bracket 26 also enable the bracket 26 to be affixed to the ledge member 14 on three separate planes for greater securement thereto. As discussed previously, the bridging elements 18 and the side elements 20 may then overlay the bracket 26 itself, thereby covering the bracket 26 from sight.

While the bracket 26 has been shown in its preferred embodiment in FIG. 13, other structural configurations of the bracket may be employed as well. FIG. 15 illustrates an alternative bracket 40, which includes a horizontal segment 42 and a vertical segment 44 disposed approximately 90° from one another. As also shown in FIG. 13, the bracket 40 does not include pair of bracket end caps, such as were arranged on either distal end of the bracket 26.

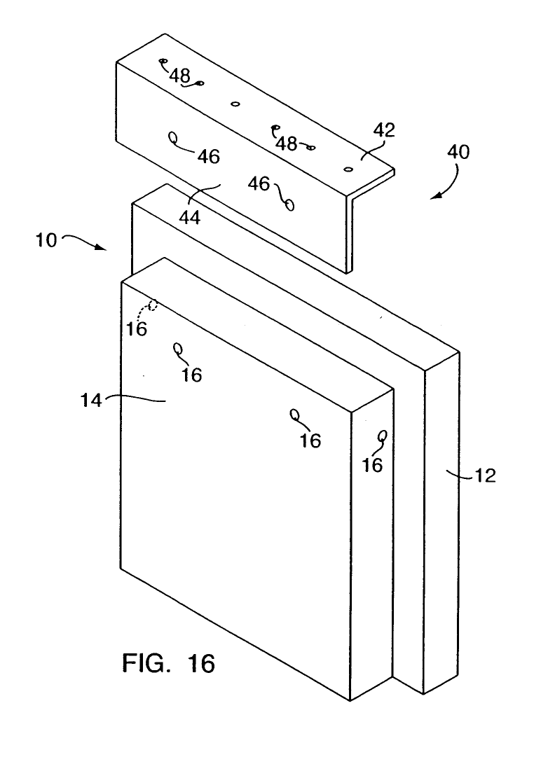

The bracket 40 is preferably formed from a thick gauge metal and includes a plurality of securement apertures 46, which are spaced so as to conform to the plurality of bores 16 formed in the ledge member 14. A plurality of attachment apertures 48 are also formed through the horizontal segment 42 and are themselves utilized to fixedly hold the bridging elements 18 in place, as discussed in conjunction with the bracket 26. It should be noted that it is still possible to utilize both the side elements 20 and the brace elements 22 with the bracket 40, which may be utilized for temporary installations or where rapid assembly and disassembly of the recessed support assembly 24 may be required, or desired, criteria. FIG. 16 depicts the bracket 40 as it is mounted upon the ledge member 14 according to this alternative embodiment of the present invention.

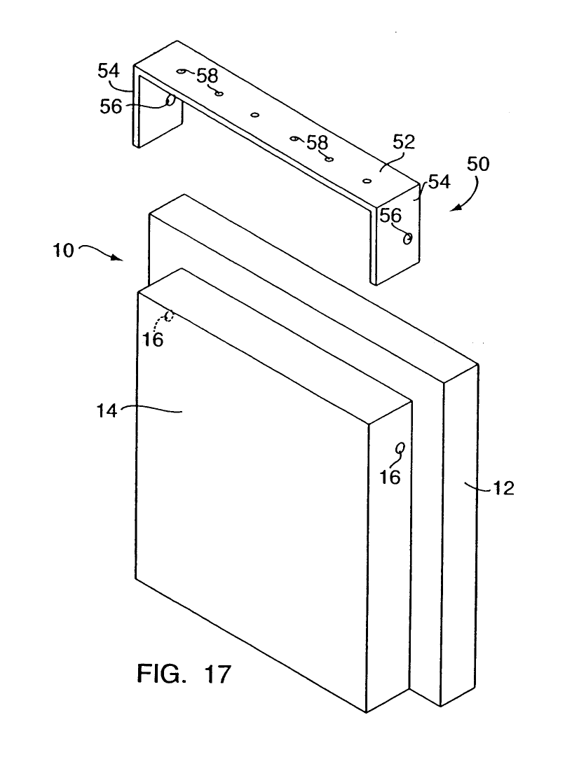

FIG. 17 illustrates an alternative bracket 50 which includes a horizontal segment 52 and a pair of end caps, or wing members, 54 disposed on either distal end of the horizontal segment 52. The bracket 50 is preferably formed from a thick gauge metal and includes a plurality of securement apertures 56, which are spaced so as to conform to the plurality of bores 16 formed in the ledge member 14. A plurality of attachment apertures 58 are also formed through the horizontal segment 52 and are themselves utilized to fixedly hold the bridging elements 18 in place, as discussed in conjunction with the bracket 26. It should be noted that it is still possible to utilize both the side elements 20 and the brace elements 22 with the bracket 50 which, as compared to the securement of the bracket 26, may be utilized for temporary installations or where rapid assembly and disassembly of the recessed support assembly 24 may be a required, or desired, criteria or utilized where no assembly hardware may be visible from any perspective.

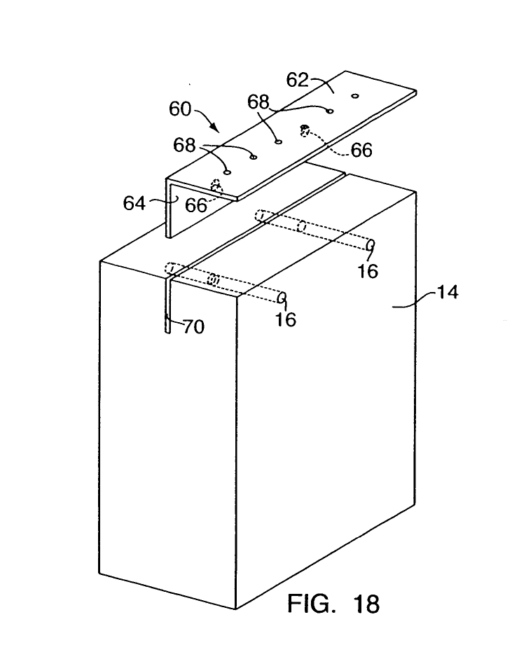

FIG. 18 illustrates yet another alternative bracket 60 which includes a horizontal segment 62 and a vertical segment 64, similar to the bracket 40 shown in FIGS. 15 and 16. The bracket 60 is also preferably formed from a thick gauge metal and includes a plurality of securement apertures 66 which are formed in the vertical segment 64 and are spaced so as to conform to the plurality of bores 16 formed in the ledge member 14. A plurality of attachment apertures 68 are themselves formed through the horizontal segment 62 and are themselves utilized to fixedly hold the bridging elements 18 in place, as discussed in conjunction with the bracket 26. It should again be noted that it is still possible to utilize both the side elements 20 and the brace elements 22 with the bracket 60 which, as compared to the securement of the bracket 26, may be utilized for temporary installations or where rapid assembly and disassembly of the recessed support assembly 24 may be required, or desired, criteria.

As will be appreciated from a review of the bracket 60 in FIG. 18, the bracket 60 does not merely overlay the ledge member 14, as was shown in conjunction with the previously described brackets, 26, 40 and 50. In contrast, the bracket 60 is instead inserted into an engagement slot 70 so as to align the securement apertures 66 with the bores 16. Vandal proof bolts, or the like, may then be utilized to secure the bracket 60 to the ledge member 14. Although FIG. 18 does not show the use of an upright member integrally attached to the ledge member 14, it will be readily appreciated that such an upright member may be employed without departing from the broader aspects of the present invention.

While FIGS. 13-18 depict brackets having a mixture of horizontal, vertical and end cap planes arranged approximately 90° from one another, the present invention is not so limited in this regard as the various constituent planes of the brackets illustrated in FIGS. 13-18 may be at any angle from one another, provided that they conform to the exterior profile of the ledge member 14.

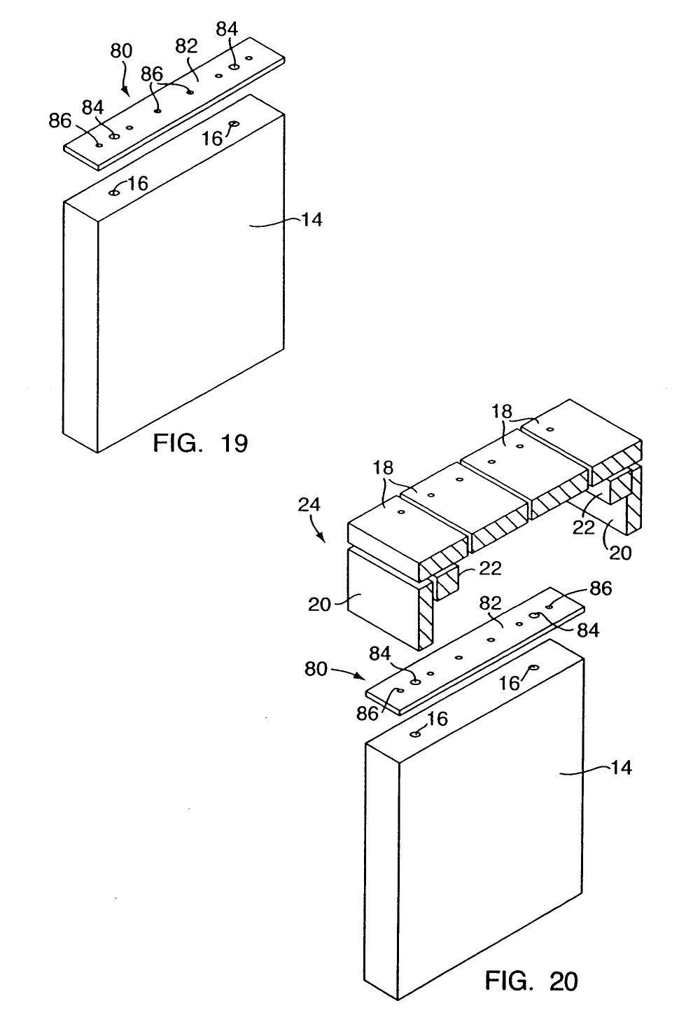

The simplest form of alternative bracket contemplated by the present invention is illustrated in FIG. 19 where a single plane bracket 80 is illustrated. As shown in FIG. 19, the bracket 80 includes only a horizontal segment 82. The bracket 80 is also preferably formed from a thick gauge metal and includes a plurality of securement apertures 84 which are formed in the horizontal segment 82 and are spaced so as to conform to the plurality of bores 16 formed in the ledge member 14, as well as a plurality of attachment apertures 86 which are also formed through the horizontal segment 82 and are themselves utilized to fixedly hold the bridging elements 18 in place, as discussed in conjunction with the bracket 26.

FIG. 20 illustrates the use of the bracket 80 as it facilitates the fastening of the bridging elements 18, the brace elements 22 and the side elements 20 to the superstructure of the ledge member 14. Although FIG. 19 does not show the use of an upright member integrally attached to the ledge member 14, it will be readily appreciated that such an upright member may be employed without departing from the broader aspects of the present invention.

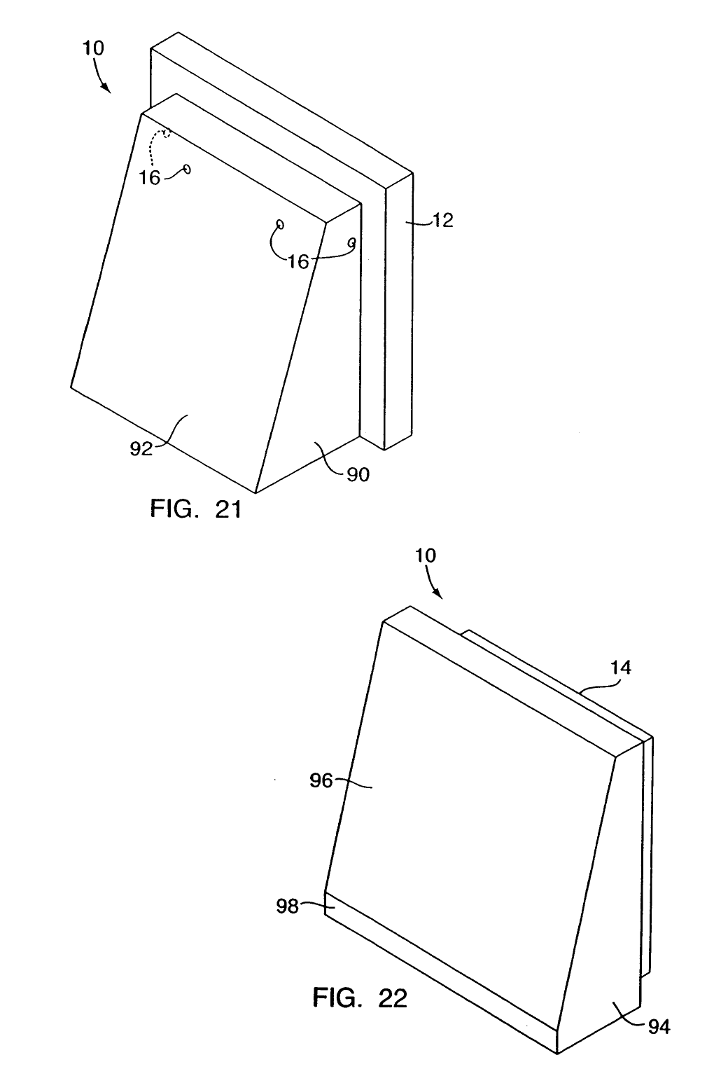

While the foregoing drawing Figures have illustrated differing structural configurations of the brackets used to help integrally fasten the recessed support assembly 24, FIGS. 21-25 depict alternative structural configurations of the ledge member 14 and the upright member 12.

As shown in FIG. 21, a ledge member 90 is illustrated integrally attached to the upright member 12. The ledge member 90 includes a sloping front face 92 having a plurality of bores 16 formed therein for securing any of the previously described brackets thereto, in dependence upon the particular structural configuration of the bracket utilized. In FIG. 22, this arrangement is substantially reversed with the ledge member 14 being planar and the upright member 94 being formed to include a sloping front face 96. The toe 98 of the upright member 94 may be attenuated as shown in FIG. 22 for the sake of extending the life of the recessed support 10, if so desired.

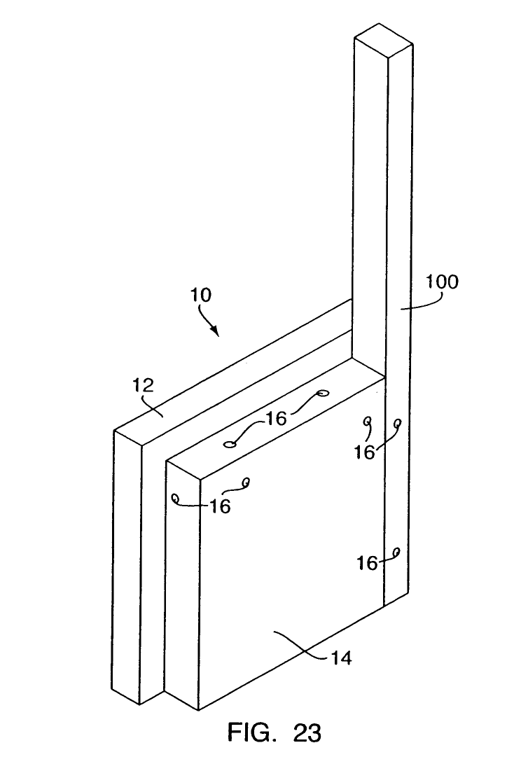

FIG. 23 illustrates a recessed support 10 having both a planar upright member 12, and a planar ledge member 14 having a back extension 100. The back extension 100 may be utilized to support back rest for the recessed support assembly is such is desired.

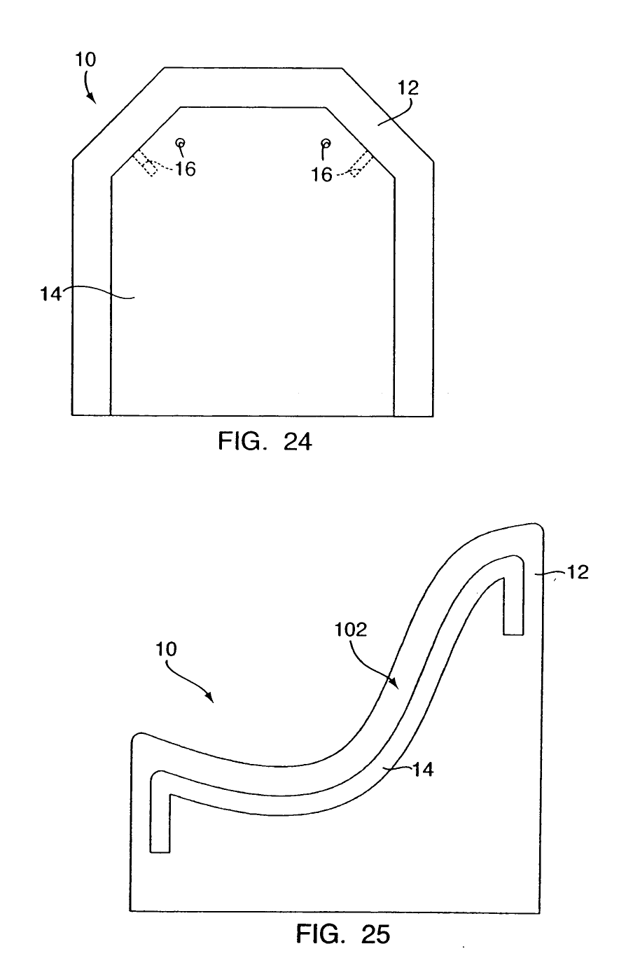

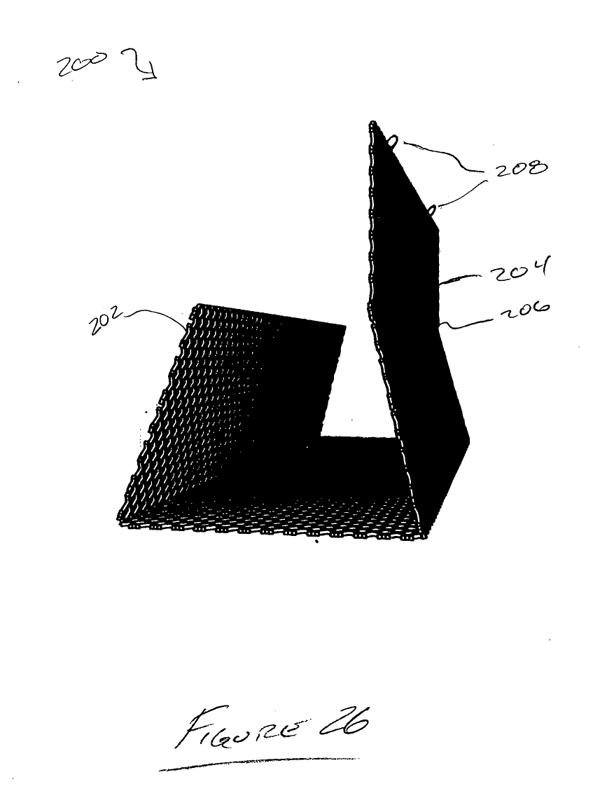

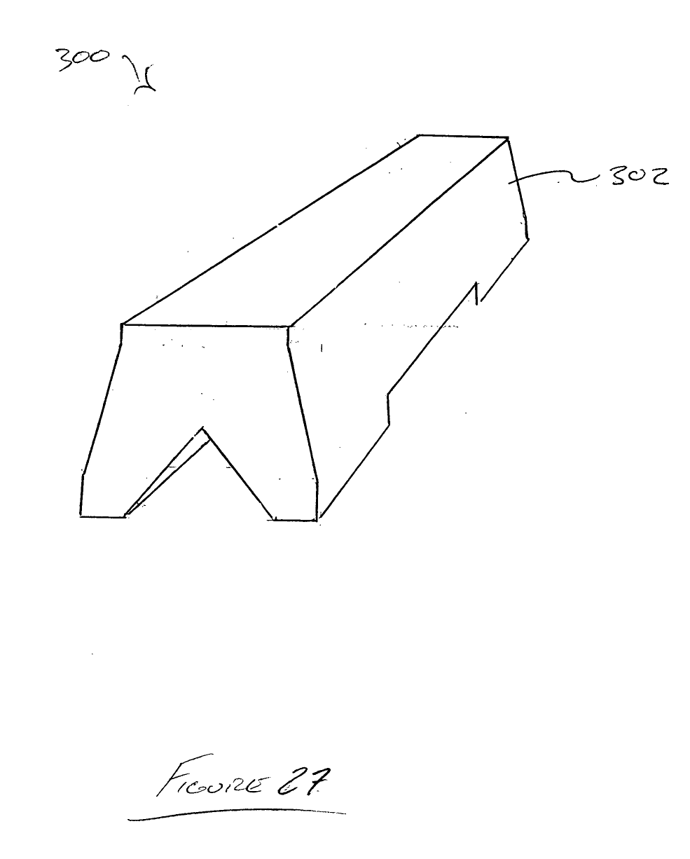

FIG. 24 is yet another example of both the upright member 12 and the ledge member 14 having a contoured profile to which the various brackets described herein would conform. FIG. 25 illustrates a recessed support 10, which includes the upright member 12 having an integrally formed backrest portion 102. Moreover, FIG. 25 further illustrates that the ledge member 14 follows the curved profile of the upright member 12 extending outwardly from the upright member 12, similar to the structural orientation of the ledge members depicted in FIGS. 10-12.

Although the present invention has described the recessed support acting as a bench, the present invention is not limited in this regard. Indeed, the present invention contemplates that the recessed support may be equally adaptable to alternative constructs, such as a table, a bed, a couch, a stand, a bridge and a bookcase or other shelving or surface elevated above the ground.

As discussed previously, the recessed support is used in pairs to form naturally supporting members upon which the distal ends of a single bridging piece, or multiple bridging pieces, may be rested. Using the brackets, the bridging element(s) may be secured to create a ridged configuration of support, and the recessed support may itself be constructed with or without internal fiber, wire, rod, mesh or other means of reinforcement.

The recessed supports of the present invention may be prefabricated, thereby enabling reproduction at one or more decentralized locations, while the design may be modified to yield multiple designs while maintaining structural integrity through the use of one or more means of reinforcement.

The brackets described herein are utilized to provide an integral median between the recessed support and the bridging element(s) supported thereon. The bracket is fixed to the recessed support and conforms to the ledge member.

While the side elements have been described, in certain embodiments, as covering the end caps of those brackets employing the same by extending approximately parallel to the bridging element(s), the present invention is not limited in this regard as the side elements any be fixed at any angle to the bridging element(s) without departing from the broader aspects of the present invention. Similarly, while the brackets depicted herein have been described as being formed from a heavy gauge metal, it will be readily appreciated that they may instead be formed from any known plastic, polymer, ceramic or other resilient materials, especially non-rusting materials, without departing from the broader aspects of the present invention.

It will also be readily appreciated that the recessed support assembly of the present invention may be stacked, oriented end-to-end or otherwise integrally constructed with other recessed support assemblies to form whatever configuration is demanded by the chosen application. Moreover, while the recessed support of the present invention has been described as being primarily utilized in pairs to form a recessed support assembly, such as a free standing bench, the present invention is not limited in this regard as it is envisioned that only a single recessed support may be utilized whereby the free end of the bridging elements not connected to the recessed support may be affixed to an existing wall, or the like, in any conventional manner.

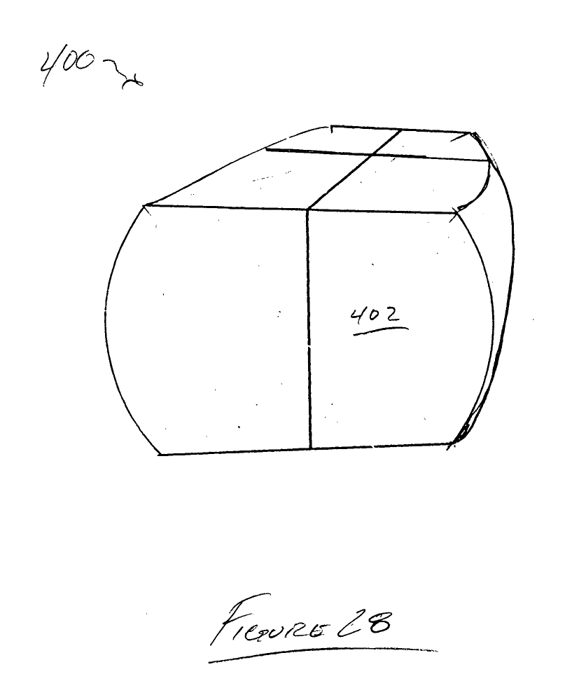

Reference will now be made to FIGS. 26-29 in which another embodiment of the present invention is depicted. In particular, FIG. 26 illustrates a security support assembly 200 wherein a screen 202, or similar enclosure, forms the desired shape of a bench base. The end panels of the security support assembly 200 have been removed from FIG. 15 for clarity's sake, however it will be readily appreciated that the security support assembly 200 does preferably include such end panels.

The screen 202 forms the base of the security support assembly 200 and may be filled with stone, sand, rock, brick, concrete, debris or other readily available materials, either natural or manmade, for the purposes of providing for ballistic and/or blast protection. An unillustrated bench top (such as previously disclosed) may be fixed to the screen base 202 by any appropriate means to provide for a seating area for users. Moreover, the top 204 of the base screen 202 may be moved from the horizontal position, to the raised or vertical position (shown in FIG. 15) via hinges 206 or the like, as desired or needed, to thereby add height to the defensive nature of the security support assembly 200.

It will be readily appreciated that while the screen base 202 is preferably formed from ballistic and/or blast resistant screening, other structurally applicable materials may be cut, bent, molded, and welded or otherwise fabricated to a particular design to define a fully enclosed cage (or screen base 202) having one or more side end panels hinged to allow the “cage” to be filled with materials suitable for design and/or security requirements. The hinged top 204 may be fit with a hasp and padlock assembly 208 or other means of making the unit secure for storage and use purposes.

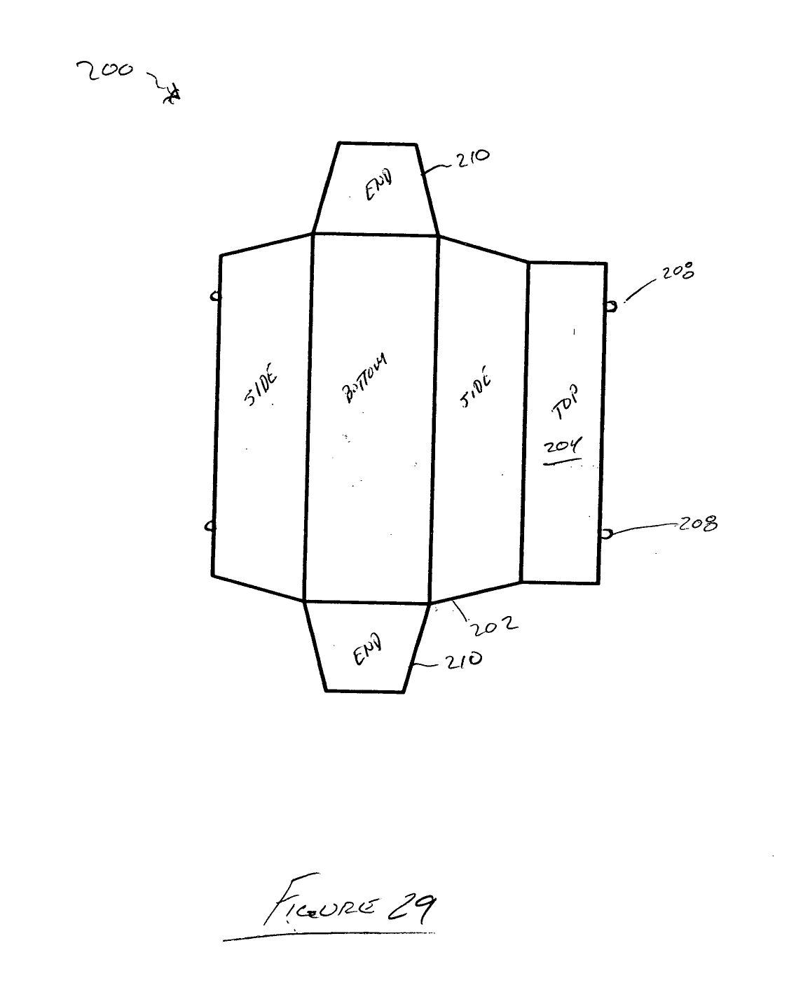

FIG. 27 illustrates yet another embodiment of the present invention in which a security support assembly 300 includes a base 302 which may be constructed of hard or soft plastic, or other similar substance, to conform, contrast or accent the surrounding architectural elements and environment and/or security requirements. In a preferred embodiment, the base 302 may be filled with water or other liquid, sand or other natural or made materials so as to provide for ballistic and/or blast protection.

As will be appreciated, the base 302 may be manufactured from plastic, lexan, fibre glass, Teflon or other materials or combinations of materials consistent with engineering, security, and/or architectural requirements.

Still yet another embodiment of the present invention is depicted in FIG. 28. As shown in FIG. 17, a security support assembly 400 includes a base 402 that may be solid or flexible, such as may be found in a balloon or beanbag. The base 402 conforms to its desired, final shape as the base 402 is filled with liquid, sand, Styrofoam or other materials consistent with engineering, security and/or architectural requirements, and for the purposes of providing for ballistic and/or blast protection. A bench top is fixed to the base 402 by any appropriate means. The non-illustrated bench top may itself be raised from the horizontal position, to a raised or vertical position, thereby adding height to the defensive nature of the security support assembly 400.

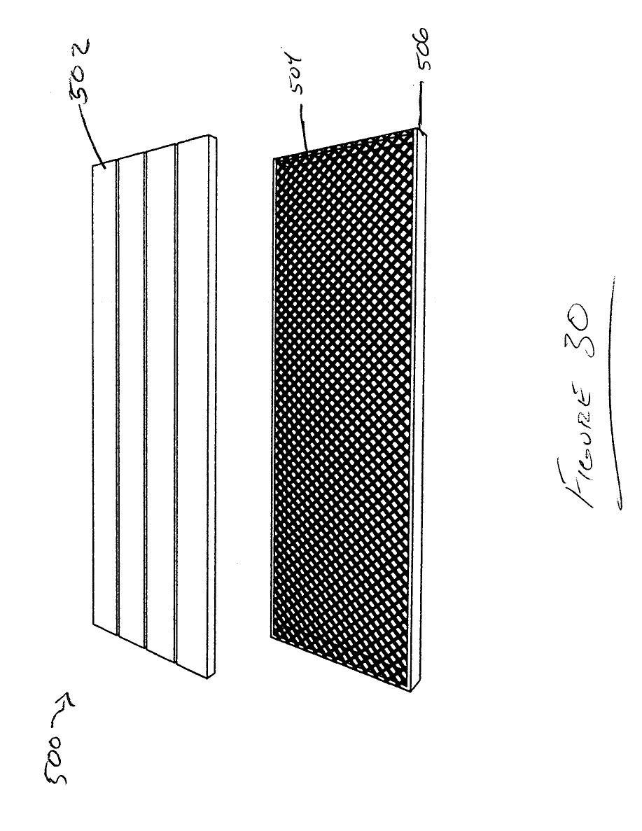

As will be appreciated, the embodiments of FIGS. 26-28 all exhibit a capacity for greater flexibility of design than is heretofore known in the art. Moreover, the embodiments depicted in FIGS. 26-28 may effectively reduce the shipping or transportation weight of the security support assembly by providing the ability to ship in a “knocked down”, or collapsed, state, thus saving the costs of construction, materials, time, shipping and handling. FIG. 29 depicts the security support assembly 200 of FIG. 26 in a collapsed or unassembled state. As shown in FIG. 29, the security support assembly 200 includes the end panels 210 and may be folded from the configuration indicated in FIG. 29 so as to lessen the size of the security support assembly 200 in anticipation of shipping or the like.

It will therefore be readily appreciated that the embodiments of FIGS. 26-28 may be expanded to accommodate a security support that has an elongated, continuous length, and that any of the embodiments of FIGS. 26-28 may be formed as a continuous barrier of various configurations having integrated public seating.

It will also be appreciated that the security support assemblies of FIGS. 26-28 could quickly be stacked one upon another, thereby forming a higher barrier. Additionally, the security support assemblies of FIGS. 26-28 could be stood on end, thus providing the necessary components of a formidable defensive wall of which the “security screen” of the bench seat may or may not be integrally used.

The security support assemblies of FIGS. 26-28 may also be used as secure storage lockers on site, or for shipping purposes. They may also be utilized themselves as shipping containers for solids, liquids or gases, or may be used as floatation devices.

The security support assemblies of FIGS. 26-28 are therefore fashioned to accommodate the bench seating made of wood or other natural or man made materials consistent with design, engineering and/or security objectives, and as described above in conjunction with the embodiments of FIGS. 1-25. Such bench seating components are attached to the security support assemblies of FIGS. 26-28 by hinge, bolts or other appropriate means. FIG. 30 exhibits one embodiment of bench seating components 500 in which the bench top 502 is disposed over a security screen 504 which itself is defined by a structural frame 506.

Thus, the present invention is consistent with the development of public seating that is attractive, may be adapted to the architectural vision of the surrounding environment and is defensive in nature.

While the invention had been described with reference to the preferred embodiments, it will be understood by those skilled in the art that various obvious changes may be made, and equivalents may be substituted for elements thereof, without departing from the essential scope of the present invention. Therefore, it is intended that the invention not be limited to the particular embodiments disclosed, but that the invention includes all embodiments falling within the scope of the appended claims.

1. A security support assembly, comprising:
a base;
said base having a top, a bottom and sides that together define an interior chamber of said base; and
wherein said interior chamber is filled with a resilient material.

2. The security support apparatus according to claim 1, wherein:
said base is formed from a wire screening.

3. The security support apparatus according to claim 1, wherein:
said base is formed from a molded material.

4. The security support apparatus according to claim 1, wherein:
said base is formed from a pliable material capable of expansion when said interior chamber is filled with a fluid.

5. The security support apparatus according to claim 1, wherein:
said top, said bottom and said sides may be folded onto one another for transportation.

6. The security support apparatus according to claim 1, wherein:
said top is hinged to one of said sides and said bottom; and
said top may be pivoted so as to provide an upwardly extending barrier.
